(19) United States
(12) Patent Application Publication
(10) Pub. No.: US 2020/0254750 A1
(43) Pub. Date: Aug. 13, 2020

(54) ROLL TRANSFER COATING METHOD FOR THICK COATING SURFACE

(71) Applicant: Sun Tool Corporation, Moriguchi shi, Osaka (CN)

(72) Inventor: Shoji HIDAKA, Moriguchi shi (JP)

(73) Assignee: Sun Tool Corporation, Moriguchi shi, Osaka (JP)

(21) Appl. No.: 16/647,408

(22) PCT Filed: Sep. 14, 2018
(86) PCT No.: PCT/JP2018/034945

§ 371 Date: Mar. 13, 2020

(30) Foreign Application Priority Data
Sep. 20, 2017 (JP) 2017-197246

(51) Int. Cl. B41F 9/06; B05D 1/28

(52) U.S. Cl. CPC B41F 9/061; B05D 1/28

(57) ABSTRACT

A roll transfer coating method for coating a coating material, which has been supplied from a coater head to a pattern surface of an intaglio roll, to a coating substrate. When the supply of the coating material is made, the supply is blocked off by a contact of the intaglio roll with the bottom surface of the coater head at a position facing the pattern surface of the intaglio roll, so that the coating material in a liquid state is supplied only into a recessed portion of the intaglio roll. Upon transferring the coating material onto the coating substrate which is being transported by a high-speed coating line, the temperature of the coating material on the pattern surface of the intaglio roll is maintained at or below a first form-changing temperature, so that the coating material in a gelled state is coated to the coating substrate.

### TECHNICAL FIELD

The present invention relates to a roll transfer coating method for forming a coating surface of a thick coating material such as a molten resin or other such material (hot melt adhesive, plastic molten resin coating agent, etc.) in a specific design pattern on a sheet-shaped coating surface such as paper, plastic film, or cloth.

### BACKGROUND ART

A known example of a plastic film that is coated with a thick coating material such as a molten resin or other such material is a fire exit light in the form of a picture or words such as “Emergency Exit” or “Evacuation Route,” in which protrusions containing phosphorescent element particles are disposed in a design pattern.

There is a known display sheet in which temperature-sensitive element particles are contained in resin protrusions to display “Caution—High Temperature.”

### PATENT DOCUMENTS

Patent Document 1: Japanese Patent Application Laid-Open (Kokai) No. H11-156290

Patent Document 2: Japanese Patent No. 5,828,469 (republished as WO 2015/177843)

Patent Document 3: Japanese Patent Application Laid-Open No. 2003-276296

### SUMMARY OF THE INVENTION

### Problems to be Solved by the Invention

There is a known technique in Patent Document 1 that relates to a thick coating surface of a molten resin or the like.

The “Method For Forming a Designable Precoat Film Including a Foaming Agent-Containing Base Coating Film” described in Patent Document 1 (Japanese Patent Application Laid-Open No. H11-156290) discloses a steel plate surface having a design surface produced by a textured surface formed by a foaming agent-containing base coating film. More specifically, it discloses a formation of a thick, textured coating surface having a design surface produced by a foaming agent-containing base coating film.

The “Method and Device for Roll Transfer Coating With a Hot-Melt Adhesive” described in Patent Document 2 (Japanese Patent No. 5,828,469; republished as WO 2015/177843)” is an invention of the present applicant, and it is similar to the invention of the present application in that it discloses a technique for roll transfer coating with a hot-melt adhesive; however, it relates to a thin-film coating surface produced by letterpress transfer. Accordingly, a change to intaglio transfer would be required in order to apply this to the invention of the present application which relates to a thick coating surface of a molten resin or the like.

The “Construction Board, and Method and Device for Printing Thereon” described in Patent Document 3 (Japanese Patent Application Laid-No. 2003-276296) discloses an intaglio transfer technique, in which excess ink is scraped away with a doctor blade (doctor knife). Therefore, a problem is that an additional member, a doctor knife, is required, and the ink and coating agent are scattered into the working environment, which is detrimental to the working environment.

Therefore, it is an object of the present invention to eliminate the need for the “doctor blade” in the invention of Patent Document 3, and, in applying the invention of Patent Document 2 to intaglio printing, to ensure that the total amount of the coating material such as a molten resin or other such material in the recessed portions of the pattern surface of an intaglio roll is transferred to the coating substrate being transported by a high-speed coating line.

### Means for Solving the Problem

The first invention of the present application provides a method for a roll transfer coating of a thick coating surface, wherein, in the supply of coating material such as a molten resin or other such material from a coater head, the supply is blocked off when the bottom surface of a coater head comes into contact with an intaglio roll at a position facing a pattern surface during the supply of the coating material to the pattern surface of the intaglio roll, so that a plastic molten resin coating agent in a liquid state is supplied only to the recessed portion of the intaglio roll, thus obtaining a thick coating surface.

The second invention of the present application provides, in addition to the first invention of the present application,

a method for a roll transfer coating of a thick coating surface, wherein, in the transfer of the coating material such as a molten resin or other such material in the recessed portion of the pattern surface of the intaglio roll onto the coating substrate, which is being transported by a high-speed coating line,

the temperature of the coating material such as a molten resin or other such material in the pattern surface of the intaglio roll is maintained, at the transfer position, at or below a first form-changing temperature, and the coating material such as a molten resin or other such material in a gelled state is coated to the coating substrate, so that a thick coating surface is obtained.

### Effects of the Invention

In the invention of the present application, a coating material such as a molten resin supplied only in the recessed portion of the pattern surface of an intaglio roll is transferred; accordingly, it has the effect that a thick coating surface can be formed, and since there is no need for a doctor knife, another effect such that the scattering of the coating material can be prevented and a favorable working environment can be maintained is provided.

The total amount of the molten resin coating material supplied into the recessed portion of the intaglio roll is reliably transferred to the coating substrate being transported by high-speed coating line. Accordingly, after passing the transfer position where the intaglio roll comes into contact with the coating substrate, there is none of the molten resin coating material remains at all in the recessed portion of the pattern surface of the intaglio roll. Therefore, since no doctor blade (doctor knife), which is described in the “Construction Board, and Method and Device for Printing Thereon” of Patent Document 3 (Japanese Patent Application Laid-Open No. 2003-276296) is required, such an effect is provided that the molten resin coating material is not scattered into the working environment, and a favorable working environment can be maintained.

### BRIEF DESCRIPTION OF THE DRAWINGS

FIG. 1 A front view of main components of a roll transfer device for implementing the invention of the present application.

FIG. 2 A developed top view of the pattern surface of an intaglio roll.

FIG. 3 A pattern developed view showing an embodiment of a coating pattern on the pattern surface.

FIG. 4 A vertical cross sectional view of a coating head (slot coater) taken at a slot groove position, illustrating a relation between the bottom surface of the coating head and the pattern surface when the supply of a coating material is blocked off.

FIG. 5 A vertical cross sectional view of the same as in FIG. 4, illustrating a state in which the coating material is supplied into a recessed portion of the intaglio roll.

FIG. 6 Shows the viscosity curve of a molten resin coating material, illustrating the relation between a change in temperature and a change in morphology of the molten resin coating material.

FIG. 7 A front view similar to FIG. 1, showing the temperature at each part of the roll transfer device and the change in the morphology of the molten resin coating material.

FIG. 8 Cross sectional views of the coating substrate after the molten resin coating material has passed a transfer position, where Figure (a) shows when the coating substrate is not permeable (such as a PP sheet), and Figure (b) shows when the coating substrate is permeable (such as a nonwoven fabric).

### BEST MODE FOR CARRYING OUT THE INVENTION

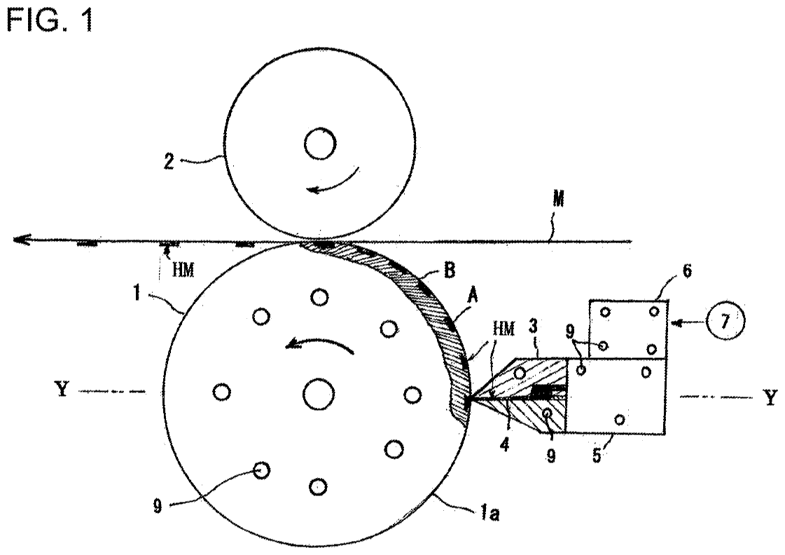

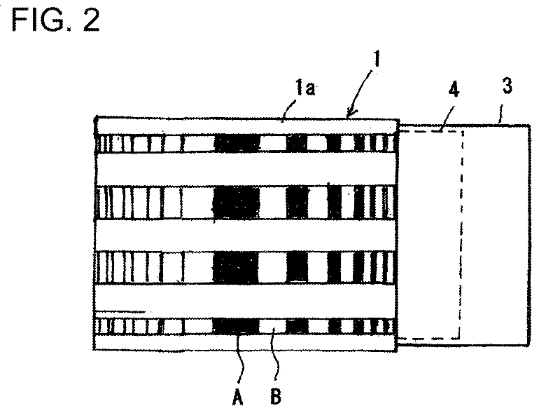

A roll transfer device for implementing the invention of the present application will be described with reference to FIG. 1. This device is constituted by a coating head (slot coater) 3, an intaglio roll 1, and a rolling mill roll 2. A coating substrate M (paper, nonwoven fabric, plastic sheet ((synthetic resin sheet)), etc.) is supplied to a transfer position between the intaglio roll 1 and the rolling mill roll 2.

The coating material supply position is set to be one-quarter rotation ahead of the transfer position, and the coating head (slot coater) 3 is installed in the coating material supply position.

In this coating head (slot coater) 3, the slot groove 4 is configured such that the center axis X in the longitudinal direction is horizontal in the radial direction through which the axis of the intaglio roll 1 passes, and the axis Y in the transverse direction is parallel to the axis of the intaglio roll 1.

The bottom surface 3a of the coating head (slot coater) 3 is provided so as to face and in contact with a pattern surface 1a of the intaglio roll 1. There is substantially zero gap is provided between the bottom surface 3a of the coating head (slot coater) 3 and the pattern surface 1a of the intaglio roll 1.

A coating pattern P is formed by forming recessed portions A on the pattern surface 1a of the intaglio roll 1.

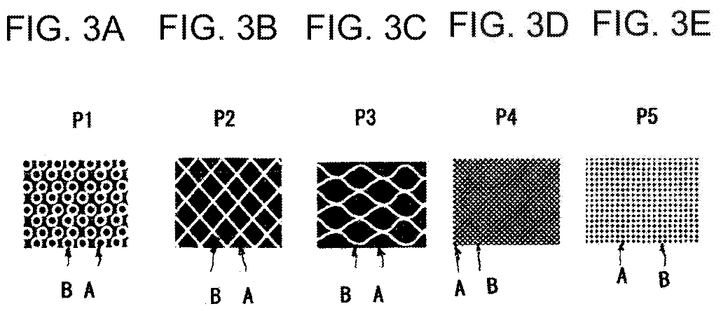

FIG. 3 shows the coating patterns P1, P2, P3, P4, and P5 as examples of the coating pattern P.

The coating pattern P can be various kinds of displays, such as alphanumeric characters, Japanese characters, symbols, pictures, etc., in addition to the patterns and figures described above.

Because of the structure above, the pattern surface 1a of the intaglio roll 1 comes into, at its smooth surface B, contact with the bottom surface 3a of the coating head (slot coater) 3, except at the recessed portions A.

In the invention of the present application shown in the roll transfer coating device of FIG. 1, the reference numeral 5 is a valve mechanism, 6 is a supply pressure adjusting device, and 7 is a supply source of a plastic heat-molting resin or other such coating material (hot melt adhesives) HM. An electric heater 9 is installed in each device, and the heater of each device is controlled to maintain the temperature of each device at its set temperature.

Next, the coating operation according to the present invention will be described.

The coating material HM, which is made by heating and melting a plastic heat-melting resin or other such coating material into a liquid state, is supplied to the slot groove 3 of the coater head, and the coating material is supplied in a direction perpendicular to the pattern surface of the pattern roll.

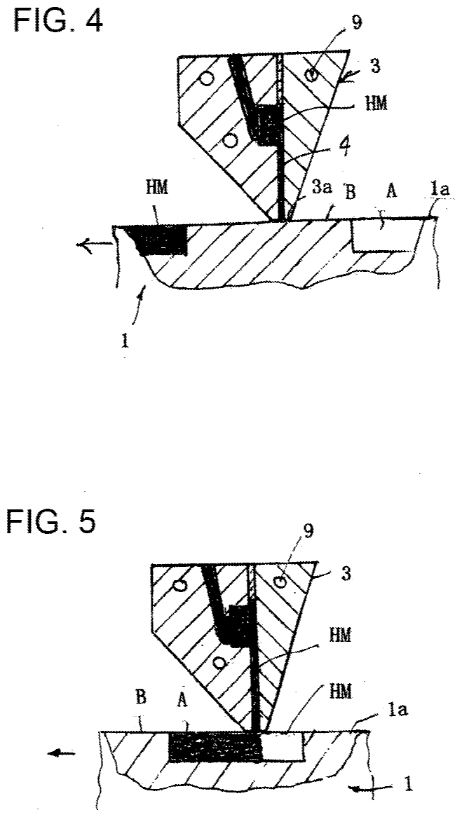

Referring to FIG. 4, the coating material is discharged from a slot groove opening 3a of the coater head; however, the discharge onto the smooth surface B of the pattern roll surface 1a is prevented

Referring to FIG. 5, the slot groove opening 3a of the coater head faces the recessed portions A of the pattern roll surface 1a.

Thus, the slot groove opening 3a of the coater head is in an open state, and the coating material (hot melt adhesive) HM fills in the recessed portions A on the pattern roll surface.

Since the coating of the coating material onto the smooth surface B is prevented, only the recessed portion A is filled with the coating material HM.

A coating pattern P is formed on the pattern surface of the pattern roll and the pattern roll is moved by rotation to the transfer position.

At the transfer position, the coating material HM is transferred to form a thick coating surface HM′ onto the coating substrate M in the form of coating pattern P.

The rotation speed of the intaglio roll 1 is set to be synchronous with the transport speed of the coating substrate M.

Next, the change of state of the coating material such as a molten resin or other such material undergoes in the method of the present invention for the roll transfer coating of a thick coating surface will be described.

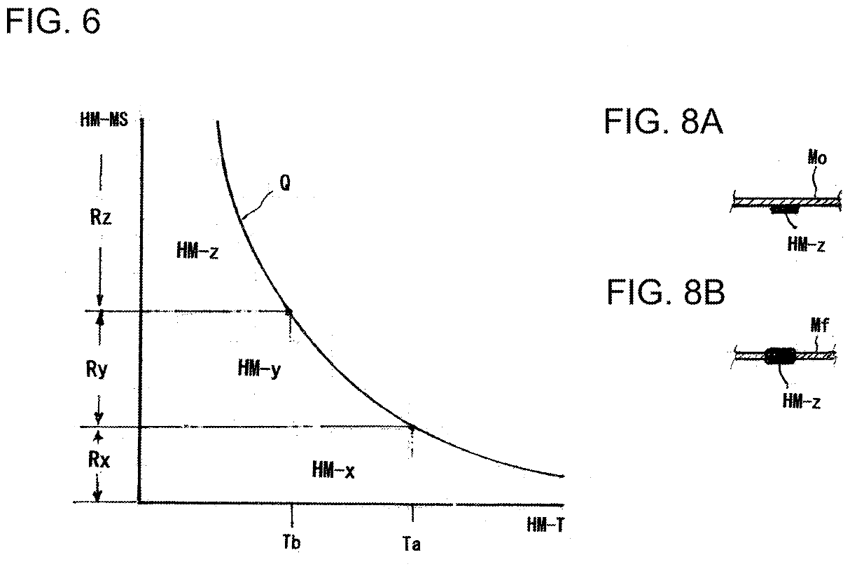

FIG. 6 shows the change of the state due to the heating temperature, wherein the temperature HM-T of the “hot melt adhesive” (coating material such as a molten resin or other such material) is shown in the X axis direction, and the substance form “liquid-gel-solid” HM-MS of the “hot melt adhesive” (coating material such as a molten resin or other such material) is shown in the Y axis direction.

Q is a viscosity curve indicative of the relationship between the temperature HM-T of the “hot melt adhesive” (coating material such as molten resin or other such material) and the substance form “liquid-gel-solid” HM-MS of the “hot melt adhesive” (coating material such as a molten resin or other such material).

Ta is a first form-changing temperature “gelling point,” and it corresponds to the change point from a liquid state to a gel state, that is, it corresponds to the temperature at which the change of state from a liquid state to a gel state begins.

Tb is a second form-changing temperature “solidification point,” and it corresponds to the temperature at which the change of state from a gel state to a solid state begins.

Rx is a liquid zone, in which the temperature of the coating material such as a molten resin or other such material is at or over the first form-changing temperature Ta.

Ry is a gel zone, in which the temperature of the coating material such as a molten resin or other such material is between the first form-changing temperature Ta and the second form-changing temperature Tb.

Rz is a solid zone, in which the temperature of the coating material such as a molten resin or other such material is at or below the second form-changing temperature Tb.

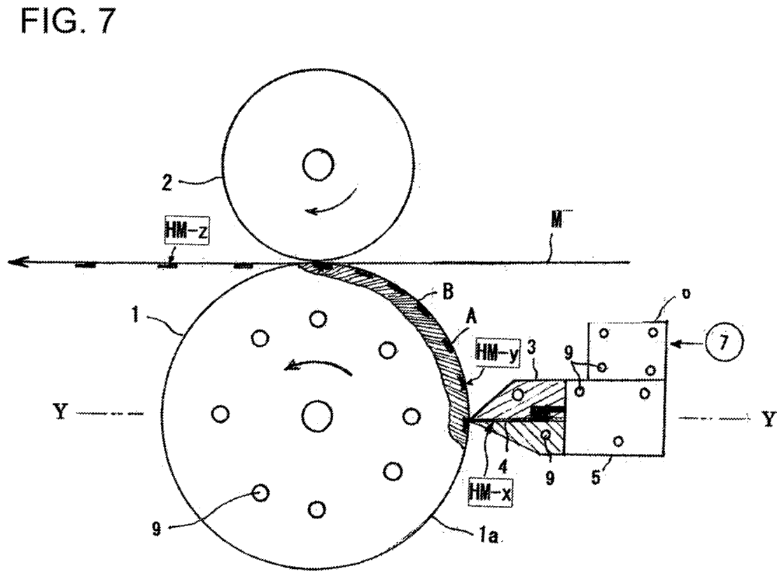

Referring to FIG. 7, the state of the coating material such as a molten resin or other such material in the coater head 3 is in the liquid zone Rx and in the liquid state HM-x, at or above the first form-changing temperature Ta

As to the state of the coating material such as a molten resin or other such material on the pattern surface of the intaglio roll, the coating material is in the liquid zone Rx and in the liquid state HM-x at the supply position from the coater head 3.

After that, as the temperature of the pattern surface of the intaglio roll decreases, the coating material such as a molten resin or other such material drops to or below the first form-changing temperature Ta and reaches the temperature of the gel zone Ry. In other words, the coating material is in the gel zone Ry and in the gel state HM-y.

At the transfer position, which faces the coating substrate M being transported by the high-speed coating line, the coating material such as a molten resin or other such material is also in the gel zone Ry and in the gel state HM-y.

The coating substrate M being transported by the high-speed coating line is maintained at room temperature, which is at or below the second form-changing temperature Tb.

Beyond the coating position, the coating material such as a molten resin or other such material coated to the coating substrate being transported cools down to a temperature close to that of the coating substrate M, which is at room temperature, thereby reaching the second form-changing temperature (solidification temperature), and the coating material is integrated with the coating substrate M in the solid state HM-z.

The hot melt adhesive HM-z transferred to the coating substrate will be described with reference to FIG. 8. If the coating substrate is not permeable, the hot melt adhesive is present only on one side of the coating substrate Mo (FIG. a). If the coating substrate is permeable (such as a nonwoven fabric sheet Mf), then the adhesive goes through the nonwoven fabric sheet Mf and is exposed on both sides of the nonwoven fabric sheet Mf (FIG. b).

The numerical values in the embodiment are listed below for reference. These values are not intended to limit the scope of the present invention and are only given for the purpose of showing that the invention of the present application can be implemented under these numerical values.
Transport speed of coating substrate M: 50 m/minute
Depth of recessed portion of intaglio roll: 0.05 to 0.5 mm
Coating head temperature: 80° C. to 120° C.
Temperature of intaglio roll: 50° C. to 80° C.
Coating amount on coating surface: 300 g/m²
Coating temperature of coating surface: 40° C. to 60° C.
Temperature of coating substrate M during transportation by coating line: room temperature
Form of hot melt adhesive HM during transfer to coating substrate M: gel-state

Next, the first form-changing temperature “gel point” Ha and the second form-changing temperature Hb are individually set and vary depending on the properties of the coating material such as a molten resin or other such material that is being used. For the sake of reference, numerical values are given below for the hot melt adhesive used in the embodiment.
First form-changing temperature Ha=80° C. to 100° C.
Second form temperature change Hb=30° C. to 60° C.

### INDUSTRIAL APPLICABILITY

The invention of the present application, in a system for manufacturing body fluid-absorbent products (such as sanitary napkins, disposable diapers, etc.), prevents a hot melt adhesive or the like from scattering when used to be coated on a coating material, which contributes to improve the working environment, and also contributes to develop the manufacturing industry of this type of coating device.

1. A method for roll transfer coating of a thick coating surface, in which a coating material that has been supplied from a coater head to a pattern surface of an intaglio roll at a supply position is coated to a coating substrate at a transfer position after a rotation of the intaglio roll, wherein
in a supply of the coating material from the coater head,
the supply is blocked off by a contact of the intaglio roll with a bottom surface of the coater head at a position facing the pattern surface,
so that a plastic molten resin coating agent in a liquid state is supplied only into a recessed portion of the intaglio roll,
thus obtaining a thick coating surface on the coating substrate.

2. A method for roll transfer coating of a thick coating surface, in which a coating material that has been supplied from a coater head to a pattern surface of an intaglio roll at a supply position is coated to a coating substrate at a transfer position after a rotation of the intaglio roll, wherein
in a supply of the coating material from the coater head,
the supply is blocked off by a contact of the intaglio roll with a bottom surface of the coater head at a position facing the pattern surface, and a plastic molten resin coating agent in a liquid state is supplied only into a recessed portion of the intaglio roll,
in a transfer of the coating material in the recessed portion of the pattern surface of the intaglio roll onto the coating substrate which is being transported by a high-speed coating line,
a temperature of the coating material on the pattern surface of the intaglio roll is maintained, at the transfer position, at or below a first form-changing temperature, so that the coating material in a gelled state is, coated to the coating substrate,
thus obtaining a thick coating surface on the coating substrate.
